(19) United States
(12) Patent Application Publication
(10) Pub. No.: US 2003/0055911 A1
(43) Pub. Date: Mar. 20, 2003

(54) System and method for retrieving data over a network

(76) Inventor: Erik Lawrence Peterson, Alamo, CA (US)

Correspondence Address: FAY KAPLUN & MARCIN, LLP, 15O BROADWAY, SUITE 702, NEW YORK, NY, 10038, US

(21) Appl. No.: 09/953,786

(22) Filed: Sep. 17, 2001

(51) Int. Cl. G06F 15/16

(52) U.S. Cl. 709/217; 709/224; 717/171

(57) ABSTRACT

A method and system are described that allow updating of data generated by a networked embedded device and displayed on a separate networked client, which reduces the communication overhead through the network. The system allows updated of one or more variables to one or more clients, and assures that the most recent value of the data is provided to the client.

### BACKGROUND OF THE INVENTION

In a computer network, information can be transferred between interconnected devices that are able to receive information and transmit information to other devices in the network. A network may include computer and non-computer devices capable of information transmission. Embedded devices are one example of non-computer devices that are capable of transmitting and receiving information via a network and web servers. Embedded devices, or devices containing embedded code and elements to execute the code, may be programmable and are generally used to control or monitor processes, machinery, environments, equipment, communications and other functions or elements. Examples of embedded devices include personal digital assistants (PDA's) and mobile telephones.

Embedded devices have become popular because they are portable, can communicate over a network, and are capable of management via the Internet. The popularity of embedded devices has also increased because web browsers and protocols promote wide data accessibility from virtually anywhere. Web browsers are a popular client interface to the Internet because of their low cost and wide availability. Protocols are also an important ingredient to wide accessibility because they are the rules that two or more networked devices (e.g., computers, switches, embedded devices etc.) must follow to exchange information. One of the most common protocols, Transmission Control Protocol (“TCP”), is an Internet standard, connection-oriented, transport layer protocol that provides reliable data transmission. Another protocol, User Datagram Protocol (“UDP”), is a simpler protocol suitable for managing data exchange between embedded devices because it is resource efficient. As a result of the wide accessibility of web browsers and protocols, web-based system management has become inexpensive, flexible and very accessible.

In some applications, simple embedded programs collect data from the device and format it into Hypertext Markup Language (“HTML”), which is the page description language used to format pages for viewing on the World Wide Web. As a result, the data is rendered as a web page, remotely accessible by standard web browsers. However, a different approach is needed to perform more complex management functions, like real-time access and control of device components such as switches and ports. JAVA® can provide such functionality. JAVA® is a computer programming language and computer software platform developed by Sun Microsystems that is open, object-oriented and contains executable programs. Under this system the web browser can support an applet, which is a JAVA® application designed to run only on a browser. The applet may allow the user to view and modify the data collected by the simple embedded program from the networked device.

### SUMMARY OF THE INVENTION

Additional features of the invention will be set forth in the description which follows, and in part will be apparent from the description, or may be learned by practice of the invention. The objectives and other advantages of the invention will be realized and attained by the apparatus and method particularly pointed out in the written description and claims hereof, as well as the appended drawings.

In one embodiment according to the present invention, a method of updating data from an embedded networked device to a client is described. The method comprises receiving a data request from the client over a network, determining at specified times whether data corresponding to the data request requires updating, and sending through the network updated data corresponding to the data request to the client, when updating is required.

In another aspect, the embodiments according to the present invention include a method of receiving updated data from an embedded networked device, comprising sending a subscription request, including a client identification and a data request, receiving initial data corresponding to the data request, and receiving updated data corresponding to the data request when data corresponding to the data request changes in the embedded networked device.

In yet another aspect, embodiments of the invention include a system for updating data over a network which comprises a client device, including a network connection to the network and a client application coupled to the network connection, and an embedded networked device, including a network connection to the network, a web server coupled to the network connection, a backplane coupled to the web server and an application coupled to the backplane. The embedded networked device sends updated data to the client device over the network when updating is required.

### BRIEF DESCRIPTION OF THE DRAWINGS

FIG. 1 is a diagram showing an exemplary embodiment of an embedded device connected via a network to a client, according to the invention;

FIG. 2 is a diagram showing a detail of an embodiment of the software for the embedded device according to the invention;

FIG. 3 is a diagram showing an embodiment of the software in an embedded device connected to a client's browser;

FIG. 4 is a diagram showing a second embodiment of the software in an embedded device connected to two client's browsers; and

FIG. 5 is a flow chart showing the steps taking place during data transfer over a network according to the invention.

### DETAILED DESCRIPTION

The present invention can be further understood with reference to the following description of preferred exemplary embodiments and the related appended drawings, wherein like elements are provided with the same reference numerals. Embodiments of the present invention will be described with reference to the JAVA® programming language as an example of a programming language that may facilitate communication between various devices within a particular system. In these embodiments, JAVA® elements such as applets and applet brokers will be used as examples of programs which can manage remote communication. However, one skilled in the art will understand that the present invention may be performed using other programming languages producing the same result.

Additionally, the preferred embodiment will be described with reference to a system having one embedded device and one or more client servers. The present invention is not limited to such a device arrangement, but may be implemented on any system where multiple devices may be managed and monitored from one or more different devices connected across a network.

Embedded devices generally include proprietary, system specific code that is designed for the management of the device but not necessarily for web-based management. Device developers cannot anticipate all future software usage of the device, and therefore may not be able to provide code translation from the system specific code to the web-based management software code. The embedded device system specific code also may not be practical for management purposes, because it may require modification each time a new management function is implemented. To alleviate this shortcoming, an additional interface may be used to facilitate communication between an embedded device and a web browser. The embedded device may use a separate, non-proprietary level of code for web-based management functions, sometimes called the glue code. That separate level of code may be controlled by the software designer, thereby leaving the system specific code intact, and giving freedom to the software designer to implement additional functions on the device.

It should be clear to those skilled in the art that the drawings are limited to showing only the software components of the embodiments according to the present invention. These embodiments may also contain hardware components such as microprocessors (for example with 32 bit or 64 bit architecture), storage devices such as random access memory or flash memory, and various other devices for processing the signals across a communication network.

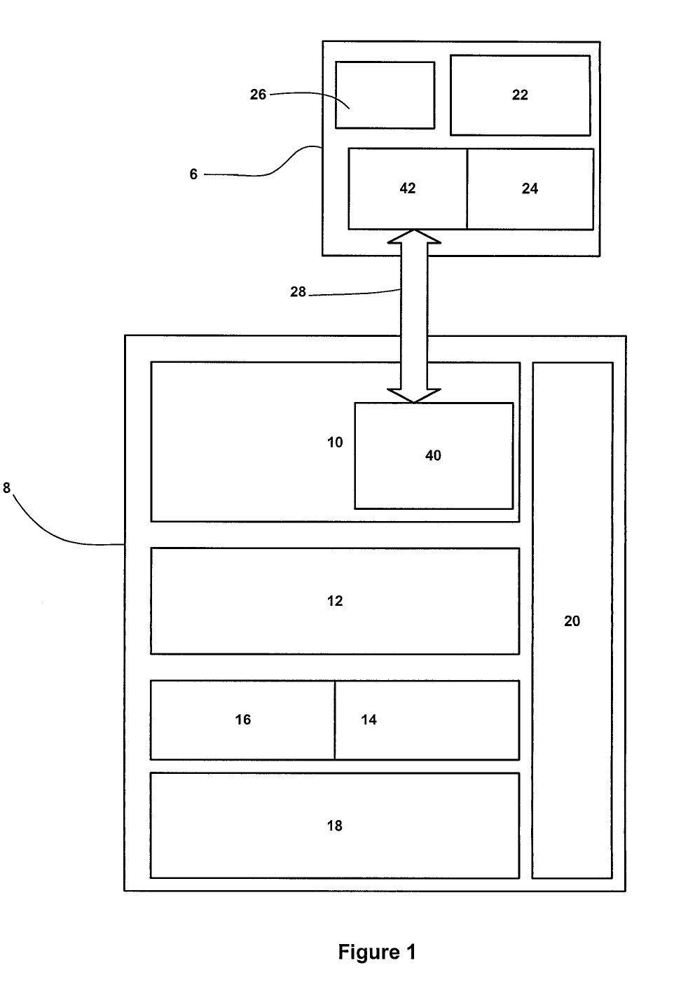

FIG. 1 shows an exemplary embodiment of a system where an embedded device 8 is connected via a network 28 to a client device 6 so that data can be transmitted between the two devices. Network 28 may be the Internet, a local area network (LAN) or another type of network where two or more devices may be interconnected. Embedded device 8 can be any networked device containing embedded code that allows it to communicate with other devices over the network 28, and particularly to exchange data with those devices. In one exemplary embodiment, client 6 can support a web browser 26, such as a Microsoft's Internet Explorer, Netscape Navigator, or other third-party web browsing software. However, the invention is not limited to this type of client.

Embedded device 8 can thus be any device that generates data which is to be transmitted to the client 6 for further display, manipulation or modification. In the following description of the exemplary embodiment, the communication and management functions between the device 8 and client 6 are carried out with JAVA®, using HTML code or applets to transmit data. Thus, once the HTML code or applet is installed on client 6, the web based software operated by the client 6 will manage the data that is transmitted by embedded device 8. This approach allows the burden of managing the data received from embedded device 8 to be shifted to the client 6, allowing device 8 to be built more economically, with limited capabilities. For example, embedded device 8 may contain fewer system resources such as RAM memory.

The exemplary embodiment of the present invention allows for a minimization of the functions carried out by the embedded device 8, to reduce the resources required by embedded device 8. Referring again to FIG. 1, several exemplary software elements of embedded device 8 are described. A web server 10 is provided to carry out the basic functions of providing a web page over the network 28 that may be accessed by browser 26 of client 6, and sending the applet 22 and associated broker 24 that are executed by client 6. Web server 10 also carries out subsequent data transfers to broker 24 via network 28, under the direction of broker 24 or of the device 8. In one example, the web server 10 may include an Hypertext Transfer Protocol (HTTP) server, a Common Gateway Interface (CGI) handler to perform data exchanges, and a Simple Mail Transfer Protocol (SMTP) element to send data out of device 8.

When the web browser 26 of client 6 executes the instructions received from embedded device 8, it interprets formatting tags embedded in the instructions to execute various programs. For example, an applet 22 may be received as an attachment to an HTML document, and may be executed by browser 26 of client 6. Those skilled in the art will understand that applet 22 may continue to be executed on client 6 after browser 26 is closed. In addition to the applet 22 itself, the web browser 26 may also receive an applet broker 24 from the embedded device 8. Both the applet and the broker may reside inactive on the device 8, until they are transferred to the client 6 and activated. The primary function of broker 24 is to manage communications with the embedded device 8 or with other networked devices through network 28. Applet 22 presents to the user an interface that allows the user to communicate with, configure, monitor and control the embedded networked device 8. One or more applets 22 may be present simultaneously on client 6, connected to embedded device 8 or to additional devices not shown in the diagram.

Client 6 may also include a caching database 42 used to store values of data received from the embedded device 8. Caching database 42 may be, for example, set up from instructions received from device 8 when executing the instructions to generate applet 22 or applet broker 24. In embodiments of the invention where a JAVA® applet is not used, web server 10 may not be able to exert control over the resources of client 6, and the caching database 42 may be excluded from the system. In this case, client 6 may only include a web browser 26 that displays a web page or a Command Line Interface (CLI) receiving information from embedded device 8. The operation of caching database 42 will be explained in detail below.

In different embodiments of the invention, web server 10 can be replaced by a server that generates a CLI page that can be accessed via Telnet by client 6, or that generates an HTML web page. Although in the following description web server 10 is adapted to send an applet to browser 26 of client 6, in other embodiments web server 10 may only send a web page or CLI page to client 6. In those embodiments JAVA® applets are not used.

Web server 10 may also function to handle data requests from applet 22, such as get data requests, set data requests, login requests from web browser 26 or from other web browsers associated with different clients. Web server 10 is designed to maintain multiple connections with several applet brokers active on several clients. Web server 10 may thus send and receive data from multiple clients. In this manner, the data generated by embedded device 8 may be accessed from different locations by pointing a web browser to the web page generated by server 10.

Web server 10 may also include a server cache 40 designed, for example, to store values of data generated by the embedded device 8. The operation of server cache 40 will be further described below.

Embedded device 8 also requires software elements to ensure its basic operation. For example, Real Time Operating System (RTOS) 20 may provide the device 8 with low level services, such as memory allocation, network services (TCP/IP) and semaphores. An exemplary RTOS 20 may include support for wide range of software and hardware platforms, and for at least some programming languages. An example of an RTOS 20 is VxWorks®, sold by Wind River Systems of Alameda, Calif. Proprietary device code 18 contains the instructions that allow the device 8 to function. For example, if the embedded device 8 is a cellular telephone, proprietary device code 18 would provide instructions for signal reception and transmission, keyboard input interpretation, and display control.

Some of the software elements residing in embedded device 8 may have the function of facilitating access to data generated in device 8 by software that is not specifically designed to work with that device. In essence, these software elements correlate the data requested or modified by an external client, such as web browser 26, with the data generated by the embedded device 8. Glue code 16 resides in embedded device 8, and may contain a plurality of read and write routines that, once selected, allow a user to get data from or post data to the proprietary device code 18. Proprietary device code 18 is the language that allows the manufacturer of embedded device 8 to control the operation of that device. Glue code 16 is thus a pathway allowing developers to access the data obtained from the hardware by proprietary device code 18.

Backplane code 12 also facilitates access to the data generated by embedded device 8, so that it is not necessary to rewrite the code utilizing the data every time a new embedded device is encountered. Backplane code 12 may include a database of variables that may be correlated by the code developer on one hand to specific items in the proprietary device code 18, and on the other hand to the corresponding data items that are received and transmitted via network 28 through the web server 10. Backplane code 12 includes “pointers” that refer the variables to the read and write routines of glue code 16, so the variables may be read from and written to the embedded device 8. For example, if a variable “nameOfUser” is handled by the web server10, backplane 12 may contain an entry including the “nameOfUser” variable name correlated to a “write” function pointer and a “read” function pointer.

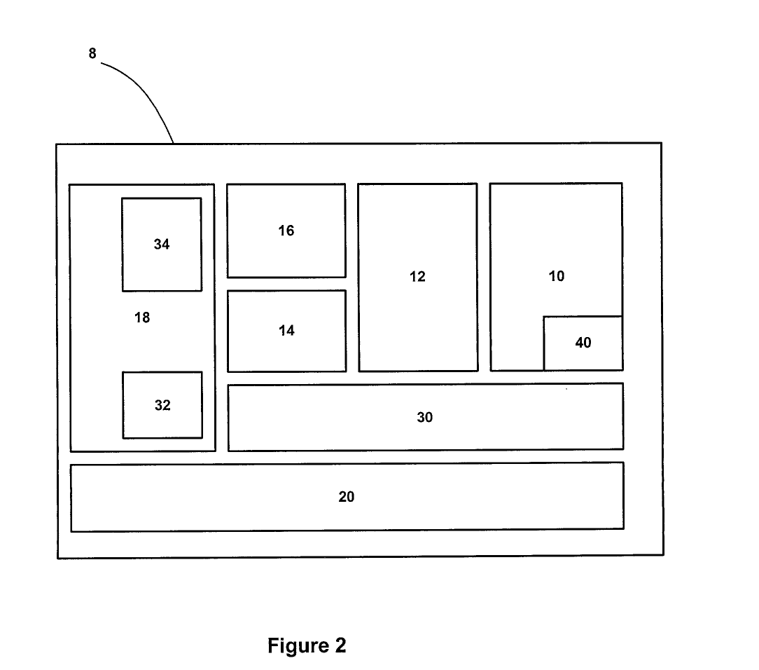

When the applet 22 is started in web browser 26, a data updating mechanism may be required between the embedded device 8 and the applet 22. In one exemplary embodiment shown in FIGS. 1 and 2, applet 22 is a display applet adapted to show a box containing the data value, a pie chart, or other graphical display of the data. The data may be generated continuously or at a set rate by the embedded device 8. Broker 24 provides updated data values to the applet 22 at a set rate, which may be selected by the user, or may be a default rate.

Unlike conventional methods, in the preferred system according to the invention a data transfer through network 28 does not take place every time that embedded device 8 generates a data value, nor every time that applet 22 or broker 24 request a data value. Instead, traffic through network 28 only takes place when the data generated by embedded device 8 changes, and not at other times. This mechanism reduces network overhead by eliminating all the network traffic that simply reports the same unchanged data value to applet 22.

Several additional software elements may be included in the programming of embedded device 8 to implement the system according to the invention. As shown in FIGS. 1 and 2, a server cache 40 is included in the design of embedded device 8. For example, server cache 40 may be part of the web server 10, and may be implemented in RAM memory, flash memory, or other known method. An operating system abstraction layer 30 may also be included, as shown in FIG. 2. Abstraction layer 30 permits software elements such as the web server 10 to make system calls to the RTOS 20, and may also take part in monitoring connections (e.g. TCP, UDP connections) and handling incoming requests from the broker 24.

Server cache 40 is used to store the current values of data generated by the proprietary code 18 of the embedded device 8. The values are updated as often as necessary under the control of abstraction layer 30 and web server 10, so that server cache 40 always contains current data values. Server cache 40 also keeps a record of which data has been requested by applet 22 through broker 24, so that only the necessary data generated in embedded device 8 is made available. In addition, if more than one broker and applet combination requests data from the same embedded device 8, server cache 40 keeps track of the data requested by each broker, and holds the identification information needed to send updated data to each broker. It will be appreciated by those skilled in the art that these memory functions may be implemented in the same physical memory or in different memories.

An additional element is also incorporated on the client 6 side, to implement the preferred system according to the invention. Caching database 42 is reserved when applet 22 and broker 24 are set up on web browser 26, and is used to store the data values received from embedded device 8. In this system, applet 22 does not directly obtain updated data values from the web server 10 of embedded device 8, through broker 24. Instead, applet 22 retrieves the data values from caching database 42 which, as will be explained below, is updated to always contain the current values of the data. Accordingly, after the initial request, broker 24 does not send a data request to embedded device 8 through the network 28 every time applet 22 requests data, greatly reducing the traffic across the network 28.

The system according to the invention can be easily extended to the exemplary embodiment where an applet 22 is not used, and caching database 42 is not reserved in client 6. In this example, broker 24 does not retrieve data from caching database 42 at a high rate. Instead, after the initial contact and subscription with web server 10, broker 24 simply waits for web server 10 to send updated values of the requested data. The updates can have the form of a new web page or CLI page.

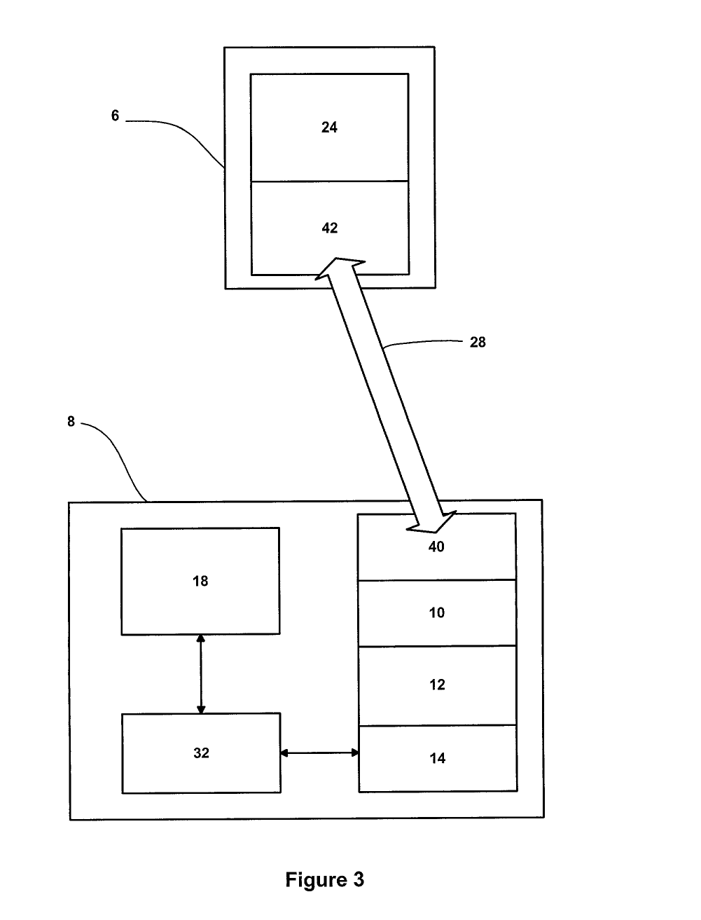

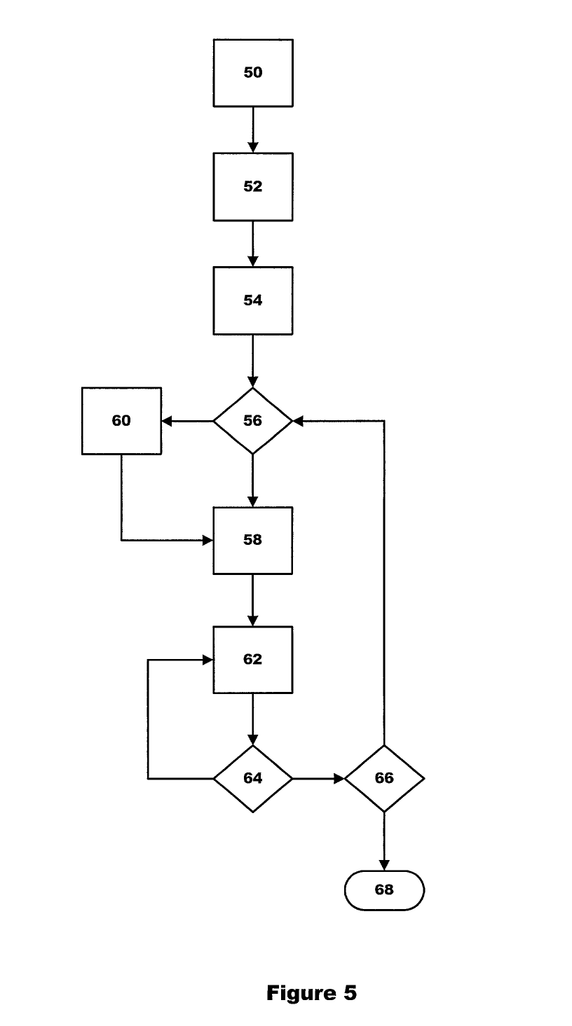

An example of the operation of the preferred embodiment will be described with reference to FIG. 3 and the flowchart of FIG. 5. FIG. 3 shows a client 6 after its browser has been directed to the web page of the embedded device 8, and after the applet 22 and broker 24 have been loaded and activated. In initial step 50 browser 26 contacts web server 10 and receives applet 22 and broker 24. In step 52 broker 24 communicates with web server 10 and subscribes to a data variable. This means that web server 10 stores in memory 40 client address and identification information for broker 24 (for example as B1), and the data requested by that broker (for example variable m1). After this initial subscription takes place in step 54, broker 24 is programmed to not request any additional data across network 28, but only to request data from caching database 42.

In step 56 the web server 10 determines whether the requested data is already available in server cache 40. Since this is a new data request, the data is not already available, and in step 60 web server 10 contacts backplane 12 to request the entries corresponding to variable m1, and glue code 16 to obtain the pointers to the read routine of proprietary code 18 that will return current values for m1. An additional Management Information Base (MIB) agent 32 may be used to further correlate the variable m1 to a reference handled by the proprietary code 18. In step 58 the current value for m1 returned by proprietary code 18 is sent through network 28 to caching database 42 as the initial value of the data, and is also stored in server cache 40 of the embedded device 8. As long as broker 24 or another broker remains subscribed to variable m1, the code embedded in device 8 continues to request values corresponding to m1 in step 62, and store them in server cache 40. However, the value corresponding to variable m1 is not sent to client 6 across the network 28 at the same rate.

The parsing rate of the data generated by embedded device 8 may be very high, and may be specified by the manufacturer of the device 8, or by the client 6. However, each successive data value is only stored in server cache 40, and is not sent to, or pushed onto caching database 42 unless there is a change in the value of m1. In this manner, once broker 24 has subscribed with web server 10 to receive values of variable m1, the only transmissions across network 28 will occur when there is a change in the variable. When a change in the value of variable m1 is detected in step 64, and the client 6 is determined in step 66 to be still subscribed, the process returns to step 56 and web server 10 transmits the updated value now in server cache 40 to caching database 42. The updated data is retrieved by broker 24 and displayed by applet 22 the next time broker 24 polls the caching database 42. The process ends in step 68 when it is determined in step 66 that client 6 has unsubscribed.

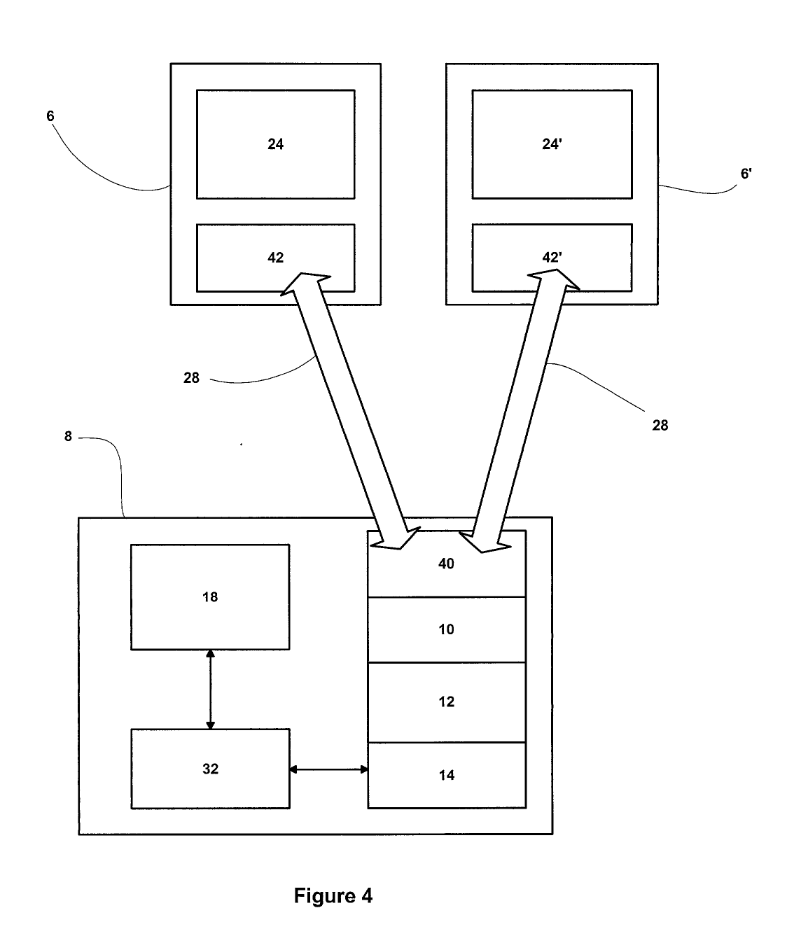

The system according to the invention may also be used in a configuration where multiple clients are requesting data from the same embedded device 8. For example, as shown in FIG. 4, clients 6 and 6′ are both connected to embedded device 8 through network 28. Client 6′ could, however, be connected through a different network. For example, this configuration may be used to monitor a process performed by an embedded device from multiple computers connected to the Internet. After client 6 subscribes to variable m1 from device 8, as described above, client 6′ may direct its browser to the web page generated by web server 10, and may start up an applet 22′ and a broker 24′ in the same manner as was done for client 6. If broker 24′ requests the same data variable m1, web server 10 may immediately send the initial value of the requested data to caching database 42′, since that data is already stored in server cache 40. Web server 10 also subscribes client 6′ to variable m1, so that any changed values of m1 will be sent to caching database 42′ as well as caching database 42.

If client 6′ requests a different data variable, for example m2, web server 10 obtains that value as described above, by availing itself of the backplane code 12 and the glue code 16 to access the read routines of proprietary code 18. Web server 10 also stores the current value of variable m2 in server cache 40, sends it to caching database 42′, and subscribes client 6′ to variable m2. As before, embedded device 8 contains code that instructs it to parse data produced by the proprietary code 18 at a given rate, and store each value to which a client has subscribed in server cache 40. Only when one of the data values changes is the updated value sent to the appropriate client, as defined in the subscription data stored in server cache 40. It will be apparent to one of ordinary skill in the art that clients 6, 6′ may subscribe to more than one variable each, and that more than two clients may take part in the system according to the invention.

After one or more clients 6, 6′ have contacted embedded device 8 and have subscribed to receive updated values for one or more variables, the information required to carry out the updates is stored in server cache 40. Although in this exemplary embodiment server cache 40 is referred to as a single cache memory, it can be implemented as separate cache memories that can be of different type. Server cache 40 may include the following exemplary entries for each subscribing client:

a. Client identification, so that initial and updated values of the requested data can be sent to the appropriate broker. (For example B1, B2 . . . )

b. One or more variables requested, which can be the same or different ones among clients. (For example m1, m2, m3 . . . )

c. Any other pertinent information, such as parsing rate within the embedded device, tolerance to determine if the variable has changed, duration of subscription.

As indicated above, caching database 42 may contain one or more initial values of the data sent by web server 10 after client 6 subscribes to the data, and any subsequent updated values sent by web server 10 when a change in the data occurs. It will be apparent to one of ordinary skill in the art that data from more than one embedded device can be handled by the system according to the invention, using one or multiple caching databases 42. Broker 24 is then free to request data from caching database 42 at any desired frequency, to display the data on applet 22.

Although the invention was described with reference to data displayed in an applet, the same system can be applied with minimal changes to other network based tools, such as HTML web pages. The specification and drawings are thus to be regarded as being illustrative rather than restrictive. It will be apparent to those skilled in the art that various modifications and variations can be made in the structure and the methodology of the present invention, without departing from the spirit or scope of the invention. Thus, it is intended that the present invention cover the modifications and variations of this invention provided they come within the scope of the appended claims and their equivalents.

What is claimed is:

1. A method of updating data from an embedded networked device to a client, comprising:
receiving a data request from the client over a network;
determining at specified times whether data corresponding to the data request requires updating; and
sending to the client through the network updated data corresponding to the data request, when updating is required.

2. The method according to claim 1, further comprising receiving a subscription request from the client through the network, the request including the data request and a client identification for the client.

3. The method according to claim 1, further comprising sending to the client through the network initial data corresponding to the data request.

4. The method according to claim 1, further comprising determining that updating is required when the data corresponding to the data request changes.

5. The method according to claim 2, further comprising polling an operating system of the embedded networked device at a first polling rate to obtain the data, and storing the data in a memory of the embedded networked device.

6. The method according to claim 5, further comprising retrieving the data from the operating system of the embedded networked device by mapping in a backplane the data to corresponding data retrieval functions.

7. The method according to claim 5, further comprising setting the updated data equal to the data stored in the memory.

8. The method according to claim 7, further comprising sending through the network the updated data from the memory of the embedded networked device.

9. The method according to claim 1, further comprising sending to the client instructions to generate an interface for transferring data with the embedded networked device.

10. A method of receiving updated data from an embedded networked device, comprising:
sending a subscription request, including a client identification and a data request;
receiving initial data corresponding to the data request; and
receiving updated data corresponding to the data request when data corresponding to the data request changes in the embedded networked device.

11. The method according to claim 10, further comprising storing the initial data and the updated data in a client memory.

12. The method according to claim 10, further comprising a preliminary step of displaying a web page of the embedded networked device, the web page containing links to send the subscription request.

13. The method according to claim 10, further comprising receiving from the embedded networked device instructions to display an interface for communicating with the embedded networked device.

14. The method according to claim 10, further comprising executing a JAVA® Applet received from the embedded networked device, the JAVA® Applet displaying the initial data and the updated data.

15. The method according to claim 11, further comprising polling the client memory at a selected polling rate to retrieve the updated data.

16. A system for updating data over a network, comprising:
a client device, including a network connection to the network and a client application coupled to the network connection; and
an embedded networked device, including a network connection to the network, a web server coupled to the network connection, a backplane coupled to the web server and an application coupled to the backplane, wherein the embedded networked device sends updated data to the client device over the network when updating is required.

17. The system according to claim 16, further comprising a backplane memory connected to the backplane, adapted to store data received from the application.

18. The system according to claim 16, wherein the web server of the networked device is adapted to send the updated data over the network to the client device when data generated by the application changes.

19. The system according to claim 16, further comprising a client memory connected to the network connection, the client memory being adapted to store data received over the network.

20. The system according to claim 19, wherein the client application is adapted to poll the client memory for the data at a selected polling rate.

21. A system for transmitting data through a network from a networked device, comprising:
a server module configured to host a web page, provide the web page in response to a request, and receive a data request and a client identification of a client;
a backplane database assigned to correlate variables specified in the data request to read routines adapted to read corresponding data from the embedded networked device; and
an abstraction module including a function library configured to control the server module and the backplane database, the function library including functions to parse the corresponding data at defined times, and to transmit the corresponding data through the network when the corresponding data changes.

22. The system according to claim 21, wherein the function library further comprises functions to send instructions to a web browser of the client to generate an interface displaying the corresponding data.

23. The system according to claim 21, wherein the function library further comprises functions to receive an additional data request and an additional client identification of an additional client, and to transmit additional data corresponding to the additional data request to the additional client when the additional corresponding data changes in the embedded networked device.

24. The system according to claim 21, further comprising a broker module adapted to be sent to the client, the broker module managing communication between the embedded networked device and the client.

25. The system according to claim 21, further comprising a memory module of the embedded networked device, the memory module storing information based at least in part on the corresponding data.

26. The system according to claim 25, wherein the memory module further stores information based at least in part on the client identification.

27. A computer-readable medium having stored thereon instructions adapted to be executed by a processor, wherein the instructions when executed initiate a method of updating data from an embedded networked device to a client, the method comprising:
receiving a data request from the client over a network;
determining at specified times whether data corresponding to the data request requires updating; and
sending through the network updated data corresponding to the data request to the client, when updating is required.

28. The computer-readable medium of claim 27, wherein the method further comprises determining that updating is required when the data corresponding to the data request changes in the embedded networked device.

29. A computer-readable medium having stored thereon instructions adapted to be executed by a processor, wherein the instructions when executed initiate a method of receiving updated data from an embedded networked device, the method comprising:
sending a subscription request, including a client identification and a data request;
receiving initial data corresponding to the data request;
receiving updated data corresponding to the data request when data corresponding to the data request changes in the embedded networked device.

30. The computer-readable medium of claim 29, wherein the method further comprises receiving instructions to generate an interface to display the initial data and the updated data.
